(19) United States
(12) Patent Application Publication
(10) Pub. No.: US 2012/0241436 A1
(43) Pub. Date: Sep. 27, 2012

(54) APPARATUS FOR CULTURING PLANT MATERIALS AS FOOD PRODUCT

(76) Inventor: GUNTER PFAFF, Port Hueneme, CA (US)

(21) Appl. No.: 13/421,536

(22) Filed: Mar. 15, 2012

Related U.S. Application Data
(60) Provisional application No. 61/467,854, filed on Mar. 25, 2011.

(51) Int. Cl. F27D 11/00

(52) U.S. Cl. 219/439

(57) ABSTRACT

The invention is directed to an apparatus adapted to prepare a cultured food product, such as but not limited to tempeh, from a plant material. The apparatus comprises a housing, a container and at least one heating element. The container holds the plant material, such as a soyfood substrate, and is incubated in the housing whereby the cultured food product, such as a tempeh, is formed. The housing further comprises a controlled airflow wherein the housing is adapted to allow ambient air to flow into and out of the housing during the culturing process.

### RELATED APPLICATION

This application claims the benefit of priority of U.S. Provisional Application Ser. No. 61/467,854, filed on Mar. 25, 2011.

### BACKGROUND OF THE INVENTION

1. Field of the Invention

This invention relates to an apparatus for preparing a cultured food product, such as but not limited to tempeh, from a plant material.

2. Description of the Related Art

Tempeh has been a valuable and important food product which is prepared by fermenting and culturing whole dehulled soybeans or soybean grits or meal with cultures of beneficial fungi or microorganisms. Although tempeh is made from soy, it has a unique taste and is mildly flavorful on its own, unlike tofu, and also has different nutritional characteristics and textual qualities. Tempeh's fermentation process and its retention of the whole bean give it a higher content of protein, dietary fiber, and vitamins. It has a firm texture and an earthy flavor which becomes more pronounced as the tempeh ages. Because of its nutritional value, tempeh is used worldwide in vegetarian cuisine; some consider it to be a meat analogue.

Tempeh can be prepared by first soaking whole soybeans in water. The soaked, wet soybeans are then dehulled and boiled in water to soften the beans and destroy any contaminating microorganisms. The cooked soybeans are then spread out in thin layers to allow the water to drain and evaporate from the surface of the soybeans. The air dried soybeans are then mixed with a starter comprising portions of old Tempeh containing a mixture of molds, bacterial and other microorganisms. The moist inoculated soybeans are then wrapped tightly and the material is allowed to culture at room temperature until the soybeans are completely molded. This product is known as tempeh, which can be eaten as is or sliced into thin slices, dipped into a salt solution and fried in a vegetable oil.

The culturing of soybeans destroys the bad odor and bad flavor of soybeans by causing the microorganisms to produce enzymes that act on the proteins, carbohydrates and the oil in the soybeans to make the tempeh palatable and nutritious and to give a desirable flavor. Examples of microorganisms used in tempeh culturing are Rhizopus oryzae and Aspergillus oryzae. These microorganisms require aeration for growth and the formation of enzymes. During the culturing process, the soybeans must be spread out in layers that are relatively shallow in depth, due to the microorganisms used in making tempeh being aerobic. Resultantly, this means that the area of the soybean layers must be large.

The use of large area trays is common for commercial production of Tempeh. Martinelli and Hesseltine (1964) Food Technology, Vol. 18, No. 5 found that large metal trays were excellent for commercial tempeh production because they were more sanitary and allowed for easier removal of the tempeh from the container in comparison to wooden trays (unless the wooden trays were lined with perforated plastic sheeting). The metal trays were reported to be preferably large aluminum trays instead of large stainless steel trays. However, the use of aluminum in prolonged contact with food is being questioned in relation to its possible implication in causing diseases, such as Alzheimers. Stainless steel is not a very good heat conductor and has less than 10 percent of the thermal conductivity of aluminum. In some instances, using stainless steel can result in a build-up of heat at the center of the tray which can cause spoilage of the tempeh in the area around the center of the tray.

A common practice in the preparation of tempeh is to cover the soybean layer with a film. The use of banana leaves in place of the film is a traditional method but can cause contamination, and the banana leaves are not reusable. Other films that can be used are polyethylene film or wax paper.

A common method of making tempeh consists of incubating a layer of soybeans covered with a flexible plastic sheet modified with aeration perforations. The incubation process takes place in an incubation room having an agitated airflow that is uniformly heated or cooled and with a consistent humidity. A disadvantage with the common method is that agitation of the airflow often leads to blackened areas on the tempeh where the airflow meets the microorganisms at the perforated holes. This contact with the fast moving airflow causes the microorganisms to sporulate prematurely and produces undesirable black spores. The greater the agitation of the airflow to ensure that the air in the incubation room does not stratify, the greater the occurrences of premature sporulation. Furthermore, it can be difficult to accurately control the humidity in the incubation rooms. If the airflow is slightly drier than optimum, the black spore problem is increased.

U.S. Pat. No. 3,228,773 to Hesseltine et al describes a method of preparing tempeh by fermenting soybeans with certain phycomycetous fungi of the order Mucorales, genus Rhizopus. The soybeans are soaked overnight, the seed coats are removed and the whole soybeans may be cracked into large grits. The soybeans are then softened and moistened by soaking in water and then boiled to sterilize and further soften the soybeans. Excess water is drained and the soybeans are cooled below 104° F. (40° C.) and then inoculated with a spore suspension of Rhizopus zopus spores. The soybeans are cultured in conventional non-toxic plastic bags modified by the presence of 0.02 inch diameter perforations located not over 0.5 inches apart. The soybeans are also described as being cultured in perforated flexible, plastic tubing having a diameter of 3.5 inches (9 cm). In either example, the resulting Tempeh must be removed from the plastic container and then cooked to prepare the Tempeh as a consumable food.

U.S. Pat. No. 5,228,396 to Pfaff describes an apparatus for culturing plant materials as food, such as tempeh, wherein the apparatus comprises at least a container, such as a stainless steel tray, holding a plant material partially immersed in a water bath, and a cover covering the container. A heater heats the water bath such that the water bath evenly distributes the heat to the container, thereby allowing the plant material to be uniformly cultured. Regulation of the temperature of the water bath is done by increasing the heat of the heater or by adding cold water to the water bath.

### SUMMARY

The invention provides various embodiments of an apparatus adapted to prepare a cultured food product, such as but not limited to tempeh, from a plant material. The invention is configured to be efficient, reliable, cost effective and can be used to prepare tempeh in large or small scale applications. The different embodiments comprise elements to alter or control the temperature during the culturing process. The elements can comprise many different materials or devices arranged in different ways, with some devices comprising a heating coil.

In one embodiment, as broadly described herein, an apparatus comprises a housing including a chamber, a container received by the chamber, and at least one heating element. The apparatus further comprises a plurality of inlet holes and a plurality of outlet holes, wherein air enters the chamber through the plurality of inlet holes and air exits the chamber through the plurality of outlet holes. The at least one heating element is configured to regulate and alter the temperature inside the apparatus to ensure that the temperature inside the apparatus is at the desired level.

In another embodiment, the apparatus comprises a housing including a top portion and a bottom portion, a support structure, a container received by the support structure and at least one heating zone adjacent the container. The apparatus can further comprise a control mechanism adapted to operate the apparatus during the process of culturing a food product. The housing comprises a plurality of inlet holes, a plurality of outlet holes and a drip screen, wherein the drip screen is adapted to prevent condensation or any contaminants from dropping onto the container.

These and other aspects and advantages of the invention will become apparent from the following detailed description and the accompanying drawings which illustrate by way of example the features of the invention.

### BRIEF DESCRIPTION OF THE DRAWINGS

FIG. 1 is a perspective view of an apparatus according to an embodiment of the invention;

FIG. 2 is a side view of the apparatus shown in FIG. 1;

FIG. 3 is a cross-sectional view of the apparatus shown in FIG. 1;

FIG. 4a is a perspective view of internal components of an apparatus according to an embodiment of the invention;

FIG. 4b is a close-up view of the internal components shown in FIG. 4a.

### DETAILED DESCRIPTION

The invention described herein is directed to different embodiments of an apparatus adapted to culture a plant material to produce a cultured food product, such as but not limited to tempeh. The apparatus can comprise many different materials and can be used in many different applications such as, but not limited to, small scale production of tempeh up to industrial scale production of tempeh. The apparatus according to the invention can be arranged in many different ways with many different components. In some embodiments, the apparatus can comprise a housing including an insulated chamber, a container adapted to receive the plant material, and at least one heating element. The apparatus further comprises a plurality of inlet holes and a plurality of outlet holes to allow air to flow through the housing. This arrangement allows air to be circulated within the housing using natural convection.

In one embodiment, as broadly described herein, an apparatus comprises a housing including an insulated chamber, a container received by the housing, and at least one heating element. The apparatus further comprises a plurality of inlet holes and a plurality of outlet holes, wherein air enters the insulated chamber through the plurality of inlet holes and air exits the insulated chamber through the plurality of outlet holes. The at least one heating element is configured to regulate and alter the temperature to ensure that the temperature inside the apparatus is at the desired level.

Culturing a plant material to make tempeh is generally known in the art. Conventional methods to make tempeh require the plant material, typically soybeans, to be soaked, dehulled, cooked and inoculated with a tempeh starter, such as portions of old tempeh and/or a mixture of molds, bacterial and other microorganisms. The soybean substrate is then incubated whereby the soybean substrate undergoes a culturing and fermentation process which produces the tempeh. The device typically used to hold the soybean substrate for the duration of the culturing process in convention methods are plastic storage bags or plastic film. The plastic bags also need to be perforated to allow excess gas to be released during the culturing process. The used plastic bags and plastic film are not reusable after the tempeh has been made, such that new plastic bag/film must be used each time tempeh is made. Furthermore, the production of the tempeh is limited to the size of the plastic bag/film, which could be a hindrance for making tempeh at a large or industrial scale. Other methods call for banana leaves or grape leaves to hold the soybean substrate for the duration of the culturing process. However, using leaves to wrap the soybean substrate is not always feasible, if not readily available, or for mass production of tempeh. Yet other devices used to hold the soybean substrate are stainless steel trays, as discussed above in U.S. Pat. No. 5,228,396 to Pfaff. However, the device in U.S. Pat. No. 5,228,396 to Pfaff, requires the stainless steel trays to be submerged in a water bath, due to the low thermal conductivity of stainless steel.

The apparatus of the invention can provide a number of advantages beyond those mentioned above. For example, in some embodiments the container section that holds the soybean substrate can be made of stainless steel and the apparatus is configured such that the soybean substrate can be properly cultured without having to submerge the container section in a water bath. This embodiment eliminates the need for the water bath, which can result in an ease of production of tempeh, as well as a reduction in cost in manufacturing tempeh. Additionally, in some embodiments, the apparatus is configured to be modular such that one apparatus can be stacked on top of and received by another apparatus.

The invention is described herein with reference to certain embodiments, but it is understood that the invention can be embodied in many different forms and should not be construed as limited to the embodiments set forth herein. In particular, the invention is described with reference to certain embodiments where the container is placed within or attached to a housing, but in other embodiments this configuration can be modified. The invention can also be used with different types of plant materials to make a cultured food product, and is not limited to a soybean substrate to make tempeh.

It is to be understood that when an element or component is referred to as being “on” another element or component, it can be directly on the other element or intervening elements may also be present. Furthermore, relative terms such as “between”, “within”, “adjacent”, “below”, “proximate” and similar terms, may be used herein to describe a relationship of one element or component to another. It is understood that these terms are intended to encompass different orientations of the device in addition to the orientation depicted in the figures.

Although the terms first, second, etc. may be used herein to describe various elements or components, these elements or components should not be limited by these terms. These terms are only used to distinguish one element or component from another. Thus, a first element discussed herein could be termed a second element without departing from the teachings of the present application. It is understood that actual systems or fixtures embodying the invention can be arranged in many different ways with many more features and elements beyond what is shown in the figures.

Embodiments of the invention are described herein with reference to illustrations that are schematic illustrations. As such, the actual thickness of elements and features can be different, and variations from the shapes of the illustrations as a result, for example, of manufacturing techniques and/or tolerances are expected. Embodiments of the invention should not be construed as limited to the particular shapes of the regions illustrated herein but are to include deviations in shapes that result, for example, from manufacturing. An element illustrated or described as square or rectangular will typically have rounded or curved features due to normal manufacturing tolerances. Thus, the elements illustrated in the figures are schematic in nature and their shapes are not intended to illustrate the precise shape of a feature of a device and are not intended to limit the scope of the invention.

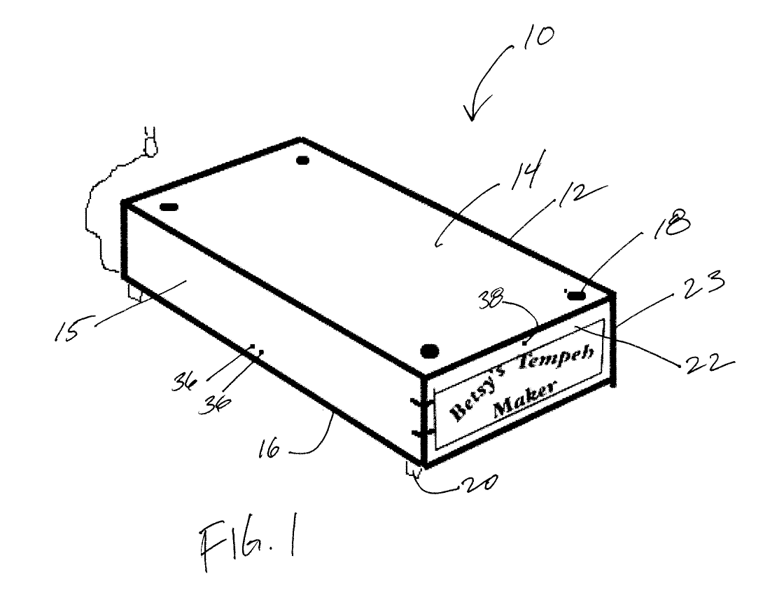

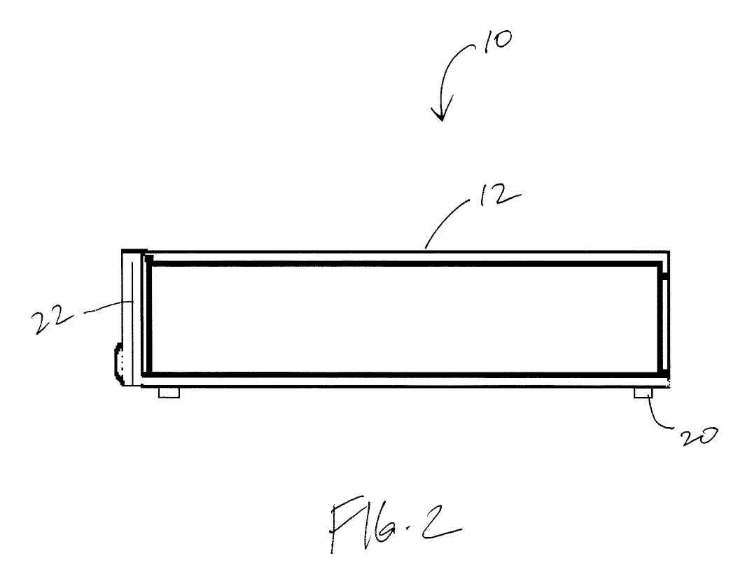

With reference to FIGS. 1-4a, an exemplary apparatus 10 is shown. In some embodiments the apparatus 10 comprises a housing 12 including a top surface 14, a bottom surface 16 opposite the top surface 14, wherein the housing 12 is adapted to receive a container 31 comprising a base section 30 and a roof section 32. The base section 30 is adapted to hold a plant material to form a cultured food product. The apparatus 10 further comprises a plurality of inlet holes 36, a plurality of outlet holes 38 and at least one heating element 40. The plurality of inlet holes 36 are configured to allow air to flow into the housing 12, while the plurality of outlet holes 38 are configured to allow air to flow out of the housing 12.

The housing 12 further comprises a plurality of sidewalls 15 that are attached to the top surface 14 and bottom surface 16, such that the top surface 14 and bottom surface 16 are separated from each other by the plurality of sidewalls 15. In the embodiment shown in FIG. 1, the housing 12 is rectangular shaped, wherein one of the sidewalls 15 is configured to be an access panel 22 having an air-tight seal and allowing access to the interior of the housing 12. However in other embodiments the housing 12 can be in the form of different shapes, such as but not limited to, a quadrilateral, circular or triangular. In yet other embodiments, the top surface 14 and the bottom surface 16 of the housing 12 are hingedly attached to allow access to the interior of the housing 12. The housing 12 further comprises an upper section 24, a chamber 25 and a lower section 26. The upper section 24 comprises the plurality of sidewalls and the top surface 14. In some embodiments, the upper section 24 can be formed of an insulation material so that the temperature inside the housing 12 can be adjusted or maintained at a desired temperature; the insulation material also prevents the loss of heat.

The lower section 26 of the housing 12 comprises the bottom surface 16 and the at least one heating element 40, such that the at least one heating element 40 is within the lower section 26 and extends along the length of the bottom surface 16, such that the at least one heating element 40 provides a uniform heat source to the lower section 26. In one embodiment, the lower section 26 comprises a plurality of heating elements 40 that are similar in size and shape and are equidistant from each other. The at least one heating element 40 can be configured in many different ways. For example, the lower section 26 can comprise a heating element 40 that extends along the perimeter of the bottom surface 16 in the form of a rectangle, and has one or more heating elements 40 extending along the length of the bottom surface 16. In yet other embodiments, the at least one heating element 40 can have many different configurations such as zigzag, serpentine, concentric, lattice, or the like. These are non-limiting examples of how the at least one heating element 40 can be configured and is not intended to be limited to the examples discussed herein.

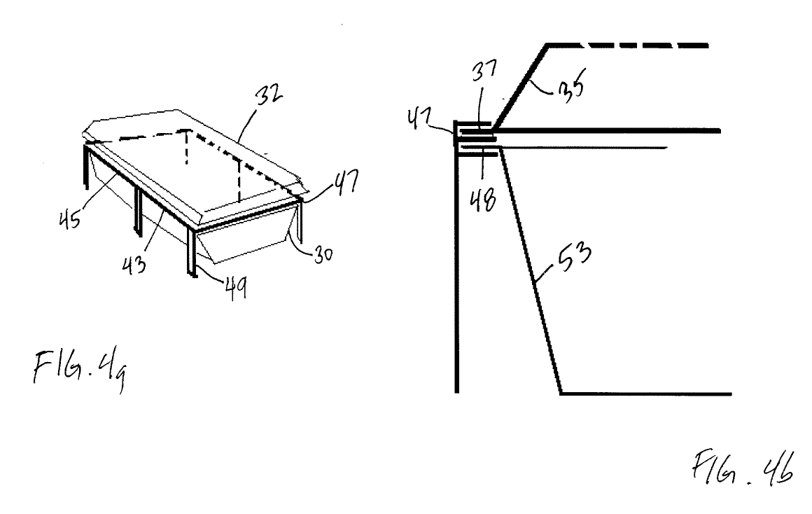

The chamber 25 of the housing 12 is adapted to receive the container 31, such that the container 31 rests on the lower section 26 or a distance away from the lower section 26. In some embodiments, the chamber 25 comprises a support structure that receives the container 31 and is adapted to hold the container 31 within the chamber 25. For example, the support structure 44 can be comprised of slots 46 which are adapted to receive the container 31, such that the container 31 can slide into the slots 46 of the chamber 25. In other embodiments, the container 31 can have an extension extending about the perimeter of the container 31, wherein the extension is placed on the slots 46 within the chamber 25. In other embodiments, the support structure 44 is a separately formed frame 45 that receives the container 31, such that the frame 45 and container 31 can be placed into and removed from the chamber 25. This arrangement allows the frame 45 to be removed such that the chamber 25 can be easily cleaned due to the lack of obtrusions that could prevent proper cleaning of the chamber 25. In the embodiment shown in FIG. 4b, the separately formed structure is a frame 45 comprising a frame body 43 including at least one channel 47 and a plurality of support extensions 49 coupled to the frame body 43 such that the at least one channel 47 receives the container 31 such that the container can slide into the at least one channel 47. In the embodiment shown in FIG. 4b, the frame 45 comprises a plurality of channels 47 on opposite portions of the frame body 43, but the at least one channel 47 can be configured in many different ways. In yet other embodiments, the container extensions can be placed on the at least one channel 47.

The container 31 is configured to receive the plant material that is to be cultured to form the food product, such as but not limited to tempeh. The container 31 comprises a base section 30 and a roof section 32 opposite the base section 30. The base section 30 comprises a base floor 51 coupled to base sidewalls 53 and a base extension 48 coupled to the base sidewalls 53 opposite the base floor 51. The base extensions 48 extend substantially perpendicularly from the base sidewalls 53. The roof section 32 comprises a perforated top 34 coupled to roof sidewalls 35 and roof extensions 37 coupled to the roof sidewalls 35 opposite the perforated top 34. The roof extensions 37 extend substantially perpendicularly from the roof sidewalls 35. The base section 30 and the roof section 32 are two individual pieces that can be utilized together to form the container 31. In other embodiments, the base section 30 and the roof section 32 are similarly shaped, whereas in other embodiments, the base section 30 and roof section 32 are distinctly shaped.

The container 31 is configured such that the roof section 32 can be placed over the base section 30 in order to form an air-tight seal about the base extensions 48 and the roof extensions 37, such that the only airflow is through the perforated top 34 of the roof section 32. The air-tight seal prevents air from flowing in and/or out between the roof extensions 37 and base extensions 48. In some embodiments, a gasket can be used between the roof extensions 37 and base extensions 48, whereas in other embodiments, the support structure 44 or frame 45 that receives the container 31 can be configured to form the air-tight seal between the base section 30 and the roof section 32 by using a gasket or the like. In yet other embodiments, the base section 30 can be attached to the roof section 32 using a screw, rivet or the like to for the air-tight seal. An advantage of the invention is that by preventing airflow between the roof extensions 37 and base extensions 48, the only airflow would be through the perforated top 34 which preserves moisture needed for proper mycelium development during the culturing of the plant material. Failure of controlling the airflow within the chamber often leads to blackened areas on the cultured food product. The blackened areas are the result of air currents which cause the microorganisms to sporulate prematurely and produce undesirable black spores. The black spores are edible and do not negatively affect the cultured food product. Proper control of the air entering the container 31 prevents the formation of blackened areas on the cultured food product.

The container 31 can be configured in many different ways and is not intended to be limited to the embodiments discussed herein. For example, the base section 30 and the roof section 32 can be hingedly attached to one another. In yet another embodiment, the roof section 32 is comprised of the perforated top 34 and roof extensions 37 such that the perforated top 34 is a planar structure or substantially flat structure that is received by the support structure 44 or the frame 45. In other embodiments the planar roof section 32 could be mounted to the housing 12 within the chamber 25 such that the base section 30 aligns with the perforated top 34 inside the chamber 25. The container 31 and the interior of the housing 12 can be made of any food grade quality material known in the art, such as but not limited to stainless steel.

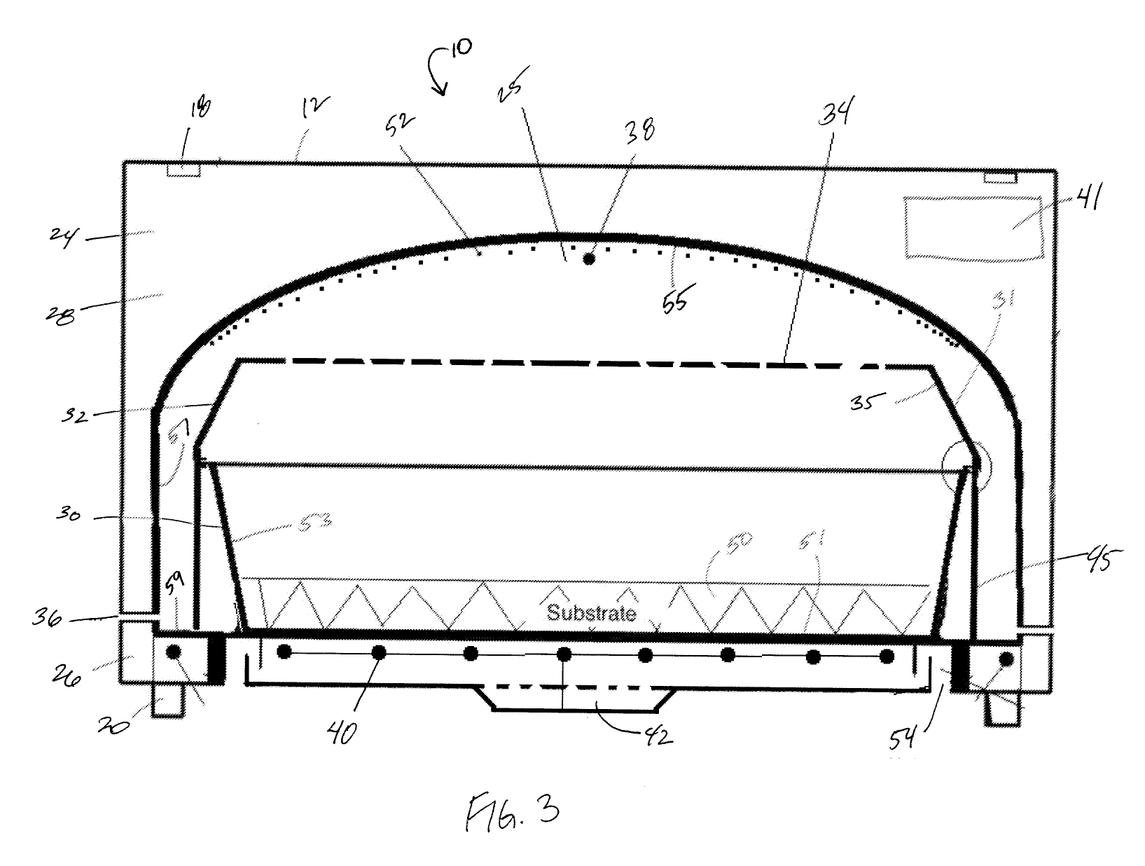

The at least one heating element 40 can be activated to heat the air inside the chamber 25 in order to culture the plant material, such as a soyfood substrate 50, in the base section 30. A first portion of the culturing process comprises an endothermic process, wherein the at least one heating element 40 heats the air within the chamber 25 of the housing 12. In some embodiments, the temperature within the chamber 25 is approximately 86-88° F. In the embodiment shown in FIG. 3, the apparatus comprises a plurality of heating elements 40 which form two heating zones, a first heating zone is comprised of the heating elements 40 within the bottom portion 26 of the housing and the second heating zone is comprised of the heating element 40 within the bottom portion 26 of the housing 12 and proximate the sidewalls 15. The first and second heating zones can be independently controlled by a control module 41. In such an embodiment, the first heating zone is configured to provide uniform heat underneath the base section 30 of the container 31. An example of the temperature underneath the base section 30 is 86-87° F. The second heating zone is configured to heat the air around the container 31 within the chamber 25. An example of the temperature around the container 31 within the chamber 25 is 88° F. However, the temperature provided by the first and second heat zones can be higher or lower than discussed herein. Additionally, the heating elements 40 of the first heating zone and second heating zone can be arranged in many different configurations as discussed herein. The apparatus can also be configured to have a plurality of heating zones.

A second portion of the culturing process comprises an exothermic process, wherein the soyfood substrate 50 generates heat and releases the generated heat into the chamber 25 of the housing 12. In order to ensure proper temperature settings within the chamber 25, the apparatus 10 can comprise a control module 41. The control module 41 is configured to detect the temperature inside the housing 12 and can control the at least one heating element 40 so as to adjust the heat output of the at least one heating element 40 in order to maintain the temperature inside the housing 12 at a predetermined temperature during the culturing process. For example, during the exothermic portion of the culturing process, the control module 41 could reduce the heat output or deactivate the at least one heating element 40 due to the soyfood substrate 50 generating heat. In embodiments comprising heating zones, the control module 41 can independently control the heat output of the respective heating zones. The apparatus 10 can further comprise a fan 42 which can also be activated by the control module 41 so as to reduce or maintain the temperature of the soyfood substrate 50 and/or the temperature inside the housing 12. Air that is blown by fan 42 can be expelled out of the lower portion 26 of the housing 12 through at least one fan exhaust 54. In some embodiments, the activation of the fan 42 and/or adjustment of the heat output of the at least one heating element 40 can be done manually, whereas in other embodiments the fan 42 and at least one heating element 40 are automatically controlled.

In order to provide the proper atmosphere for the culturing process, fresh air will be allowed to enter the apparatus 10. The housing 12 comprises a plurality of air inlet holes 36 disposed on opposing sidewalls 15 of the housing 12 and are proximate the bottom surface 16 of the housing 12. Air will also be allowed to exit the apparatus through natural convection via a plurality of air outlet holes 38 disposed on opposing sidewalls 15 of the housing, wherein the plurality of air outlet holes 38 are disposed on opposing sidewalls 15 which do not already have air inlet holes 36. The plurality of air outlet holes 38 are proximate the top surface 14 of the housing and can be configured such that the air outlet holes 38 form an angled channel, such that the channel opening inside the housing 12 is at a lower position than the channel opening at the sidewall 15 of the housing. An advantage of the invention is that the angled channel takes advantage of natural convection to allow heated air from exiting the housing 12. In other embodiments, the inlet holes 36 and/or outlet holes 38 can be configured such that they are substantially perpendicular to the sidewalls 15, angled or a combination thereof. In yet other embodiments, the inlet holes 36 and outlet holes 38 can be disposed on the same sidewalls 15.

During the culturing process, condensation may form within the housing 12 and in particular in the vicinity of the plurality of the air outlet holes 38 and/or on the upper surface of the housing. A collection of condensation within the housing 12 could collect on the upper surface 55 of the chamber and could cause water drops to fall onto the soyfood substrate 50 within the container 31. Water that comes into contact with the soyfood substrate 50 during the culturing process could negatively impact the soyfood substrate 50 and even kill the beneficial microorganism that is added to the soyfood substrate 50, thereby hindering or stopping the development of the tempeh. In order to prevent water from coming into contact with the soyfood substrate 50, the housing 12 can comprise a drip screen 52 adjacent the upper surface 55 of the chamber 25, wherein the drip screen 52 catches any condensation that may drop from within the chamber 25 and/or the plurality of air outlet holes 38. In yet another embodiment, the drip screen 52 can be adapted to guide the received condensation away from the perforated top 34 of the container 31 and/or discard the received condensation. The drip screen 52 can be shaped such that the received condensation flows towards the chamber sidewalls 57 so that the condensation can trickle down the chamber sidewalls 57 towards the chamber floor 59. The upper surface 55 of the chamber 25 can have a curved shape to direct condensation towards the chamber sidewalls 57. The upper surface 55 can be arranged in many different shapes and is not intended to be limited to a curved shape. An advantage of the invention is that the condensation collected on the chamber floor 59 assists in maintaining the proper humidity levels inside the housing 12.

The control module 41, upon determination that the culturing process is complete, can be configured to activate the at least one heating element 40 so as to pasteurize the cultured food product. In some embodiments, the temperature used to pasteurize the cultured food product is 160° F., thereby killing the beneficial microorganism added to the soyfood substrate 50. In some embodiments, pasteurizing the cultured food product could be done automatically, whereas in other embodiments the at least one heating element 40 can be manually activated. The automation of the apparatus 10 can be governed by a number of factors such as but not limited to temperature, humidity, time and/or a combination thereof. In some embodiments, a period of elapsed time could trigger an automated event such as turning off the at least one heating element 40 to coincide with the endothermic portion of the culturing process. In yet other embodiments, the control module 41 further monitors conditions within the housing 12 to ensure that the triggered event properly occurs due to the elapsed period of time.

The invention is described herein with reference to certain embodiments, but it is understood that the invention can be embodied in many different forms and should not be construed as limited to the embodiments set forth herein. For example, the embodiments herein disclose an individual apparatus for culturing a soyfood substrate. However, a plurality of apparatuses mounted one above the other or side-by-side in a spatial relationship can be used. The housing can comprise a plurality of extensions coupled to the lower section of the housing and are configured to be received by a respective one of a plurality of depressions on the top surface of the housing. In this manner, a soyfood substrate can be cultured on an industrial scale. In yet other embodiments, the heat within the apparatus can be regulated by a single heating element. Yet further, the heating element can be an electric heating coil or the like. Also, other beneficial microorganisms can be used other than a fungus of the genus Rhizopus. While various implementations of the application have been described, it will be apparent to those of ordinary skill in the art that many more embodiments and implementations are possible that are within the scope of this invention.

We claim:

1. An apparatus, comprising:
a housing including upper section, a lower section and a chamber;
a container including a base section and a roof section, wherein the roof section is perforated;
at least one heating element; and
a plurality of inlet holes and outlet holes, wherein said inlet holes are adapted to allow air to enter the housing and said outlet holes are adapted to allow air to exit the housing.

2. The apparatus of claim 1, wherein said container is received by said chamber of said housing.

3. The apparatus of claim 2, wherein said container is on a support structure within said chamber of said housing.

4. The apparatus of claim 1, wherein said at least one heating element provides uniform heat to said container.

5. The apparatus of claim 4, wherein said at least one heating element heats air within said chamber proximate said container.

6. The apparatus of claim 1, wherein the air entering said housing through said plurality of inlet holes ambient air and the air exiting said housing through said plurality of outlet holes is heated air.

7. The apparatus of claim 1, further comprising a drip screen within said housing, wherein said drip screen is interposed between said container and said upper section such that said drip screen is adapted to prevent condensation from entering said container.

8. The apparatus of claim 7, wherein said drip screen is further configured to discard any received condensation away from said container and towards at least one chamber sidewall.

9. The apparatus of claim 1, said housing comprising an access panel to allow access to said chamber.

10. The apparatus of claim 1, further comprising:
a fan; and
a control module.

11. The apparatus of claim 10, wherein said control module is adapted to detect the temperature within said housing, wherein said control module regulates the temperature within said housing at a desired setting.

12. The apparatus of claim 11, wherein said control module can adjust the heat output of said at least one heating element in response to the temperature inside said housing.

13. The apparatus of claim 10, wherein said fan is adapted to be activated to maintain or lower the temperature within said housing.

14. The apparatus of claim 10, wherein said fan is adapted to be activated to maintain or lower the temperature within said container.

15. The apparatus of claim 1, wherein said plurality of air outlet holes forms an angled channel, such that an opening on an interior surface of said housing is at a lower position than the opening on an exterior surface of said housing.

16. The apparatus of claim 1, wherein said housing is thermally insulated to maintain the temperature at a constant setting within said housing.

17. The apparatus of claim 1, wherein said housing further comprises a plurality of depression on an upper surface and a plurality of extensions at a bottom surface of said housing.

18. The apparatus of claim 17, wherein said housing is adapted to be modular, such that said plurality of depressions are configured to receive a respective plurality of extensions from another housing, whereby a plurality of housings can be securely stacked on top of one another.

19. The apparatus of claim 1, wherein said at least one heating element is configured to form a first heating zone and a second heating zone.

20. The apparatus of claim 19, wherein said first heating zone is adapted to provide uniform heat to said base section of said container, and said second heating zone is adapted to heat the air in said chamber and around said container.
